(19) United States
(12) Patent Application Publication
(10) Pub. No.: US 2009/0051614 A1
(43) Pub. Date: Feb. 26, 2009

(54) FOLDED DIPOLE ANTENNA

(76) Inventors: Hang WONG, Hong Kong (HK); Kwai Man Luk, Hong Kong (HK); Quan Xue, Hong Kong (HK); Chi Hou Chan, Hong Kong (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/840,999

(22) Filed: Aug. 20, 2007

(51) Int. Cl. H01Q 9/26; H01Q 1/38; H01Q 9/04

(52) U.S. Cl. 343/803; 343/700 MS

(57) ABSTRACT

A folded dipole antenna that transmits and receives radio frequency waves (RF) waves has two radiating strips that form a dipole. A metallic radiating element is located between the two radiating strips, facilitating an increase in the gain of the antenna. The folded dipole antenna may be used in a wireless communication device.

### BACKGROUND OF THE INVENTION

The present invention relates generally to wireless communications, and more specifically, to dipole antennas used in wireless communications.

An antenna is an important element in a wireless communication device. Examples of a wireless communication device include a cellular telephone, a laptop computer, a Personal Digital Assistant (PDA), a radio set, a wireless controller and a pager. The antenna in a wireless communication device serves as an aerial interface for transmitting and receiving Radio Frequency (RF) waves.

A dipole antenna has an electrically conducting wire that is split in the centre. Each end at the centre is connected to a feed line. Dipole antennas that are formed by depositing a radiating material on a Printed Circuit Board (PCB) are known as printed dipole antennas. The radiating material may be any metal that is capable of radiating RF waves. A dipole antenna can be folded into an irregular shape to save area on the PCB. Such a dipole antenna is known as a Folded Dipole Antenna. A folded dipole antenna has two radiating strips that are formed on the PCB and separated by a finite distance. Generally, the length of the folded dipole antenna used in a wireless communication device is equal to one-half of the wavelength of the RF signal. Nowadays, the length of folded dipole antennas used in wireless communication devices has been reduced to approximately one-fourth of the wavelength of the RF signal, in an effort to reduce the size of the wireless communication devices. However, reducing the length results in degradation in gain and in the radiation efficiency of the antenna, as well as deterioration in its radiation performance. Moreover, the input impedance of a folded dipole antenna with a length that is equal to half the wavelength of the RF signal is about 73 ohms. Reducing the length of the antenna to less than half the wavelength of the RF signal results in a reduction in input impedance. This reduction in the input impedance is undesirable, particularly when it is crucial to transfer maximum RF power to the inputs of the folded dipole antenna.

In a wireless communication device, the folded dipole antenna is connected to a Radio Frequency Integrated Circuit (RFIC) through a balun. The balun functions as an adaptor between the differential ports of the RFIC and the single-ended port of the folded dipole antenna. However, the balun results in increased utilization of PCB area. Further, an RF switch needs to be used when a single folded dipole antenna is used for transmission as well as for reception. The RF switch switches between the transmission and reception ports of the RFIC, depending on the mode of operation of the antenna. However, the RF switch also increases the PCB area occupied by the antenna.

### BRIEF DESCRIPTION OF THE DRAWINGS

The following detailed description of preferred embodiments of the present invention will be better understood when read in conjunction with the appended drawings. The present invention is illustrated by way of example, and not limited by the accompanying figures, in which like references indicate similar elements.

FIG. 1 is a schematic diagram illustrating a folded dipole antenna with a metallic radiating element, in accordance with an embodiment of the present invention;

FIG. 2 is a graph illustrating a gain comparison between a folded dipole antenna with a metallic radiating element and a folded dipole antenna without a metallic radiating element, in accordance with an embodiment of the present invention;

FIG. 3 is a radiation pattern illustrating the vertical and horizontal polarization of a folded dipole antenna, in vertical configuration, in accordance with an embodiment of the present invention;

FIG. 4 is a radiation pattern illustrating the vertical and horizontal polarization of a folded dipole antenna, in horizontal configuration, in accordance with an embodiment of the present invention; and

FIG. 5 is a block diagram of a wireless communication device with a folded dipole antenna, in accordance with an embodiment of the present invention.

### DETAILED DESCRIPTION OF THE PRESENT INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a folded dipole antenna with a metallic radiating element is provided for transmitting and receiving Radio Frequency (RF) waves. The folded dipole antenna has two radiating strips that are separated from each other by a predetermined distance. A metallic radiating element is formed between the two radiating strips.

In another embodiment of the present invention, a wireless communication device with a folded dipole antenna is provided. The wireless communication device includes a transmitting folded dipole antenna and a receiving folded dipole antenna. Each of the transmitting and receiving folded dipole antennas has two metallic radiating strips that are separated from each other by a predetermined distance. A metallic radiating element is formed between the two radiating strips. The transmitting and receiving folded dipole antennas each has two input ports that are connected to the differential ports of a Radio Frequency Integrated Circuit (RFIC).

Embodiments of the present invention provide a folded dipole antenna with a metallic radiating element. The presence of the metallic radiating element improves the gain of the folded dipole antenna, even if the length of the folded dipole antenna is less than one-half the wavelength of the RF waves or is equal to about one-fourth of the wavelength of the RF waves. When the folded dipole antenna is connected to a feed line, some currents flow into the metallic radiating element, resulting in the amplitude of the current density at the metallic radiating element being nearly equal to the amplitude of the current density along the two radiating strips. Thus, the metallic radiating element contributes to the overall radiation of the RF waves of the folded dipole antenna. Hence, the folded dipole antenna has an improved gain, and thereby achieves an improved radiation efficiency and performance. The folded dipole antenna has high input impedance due to the presence of the radiating metallic element. The folded dipole antenna has two input ports that may be connected to the differential ports of the RFIC. This eliminates the need of a balun between the folded dipole antenna and the RFIC and results in reduced space being occupied by the folded dipole antenna on a PCB. The transmitting and receiving folded dipole antennas may be fabricated in a stacked structure on the PCB, thereby eliminating the need for an RF switch. This further facilitates reduced PCB space consumption.

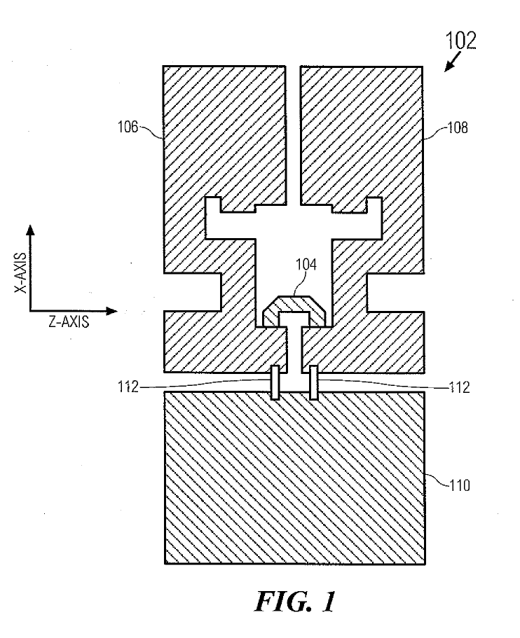

Referring now to FIG. 1, a schematic diagram illustrating a folded dipole antenna 102 with a metallic radiating element 104 is shown, in accordance with an embodiment of the present invention. The folded dipole antenna 102 includes a first radiating strip 106 and a second radiating strip 108. The first and second radiating strips 106 and 108 form a dipole. The first and second radiating strips 106, 108 are folded in an irregular planar structure and are separated by a predetermined distance. The predetermined distance between the two radiating strips can be chosen from about 1 mm (0.008λ) to about 10 mm (0.08λ). The metallic radiating element 104 is located between the first and second radiating strips 106, 108. The metallic radiating element 104 connects the first radiating strip 106 and the second radiating strip 108. The first radiating strip 106 and the second radiating strip 108 are connected to a pair of input ports 112. The ground plane 110 is substantially parallel to the plane of the first radiating strip 106, the second radiating strip 108 and the metallic radiating element 104.

In various embodiments of the present invention, the folded dipole antenna 102 may be a planar inverted-F antenna (PIFA). The first and second radiating strips 106 and 108 may be mirror images of each other. The first radiating strip 106, the second radiating strip 108, the metallic radiating element 104 and the ground plane 110 lie in the same plane. The metallic radiating element 104 can have various shapes, like C, M, V, W, etc., that connect the two radiating elements 106 and 108 in a symmetric form. In one embodiment of the present invention, the metallic radiating element 104 is generally U-shaped.

The combined length of the first radiating strip 106 and the second radiating strip 108 along the Z-axis is equal to about one-fourth of the wavelength of the RF waves. The first radiating strip 106, the second radiating strip 108, the metallic radiating element 104 and the ground plane 110 may be formed on a printed circuit board (PCB). The first radiating strip 106, the second radiating strip 108, the metallic radiating element 104 and the ground plane 110 may be formed using a radiating material such as copper, aluminium, or any alloy or mixture, etc. In one embodiment of the present invention, the folded dipole antenna 102 has a high input impedance of about 80 ohms.

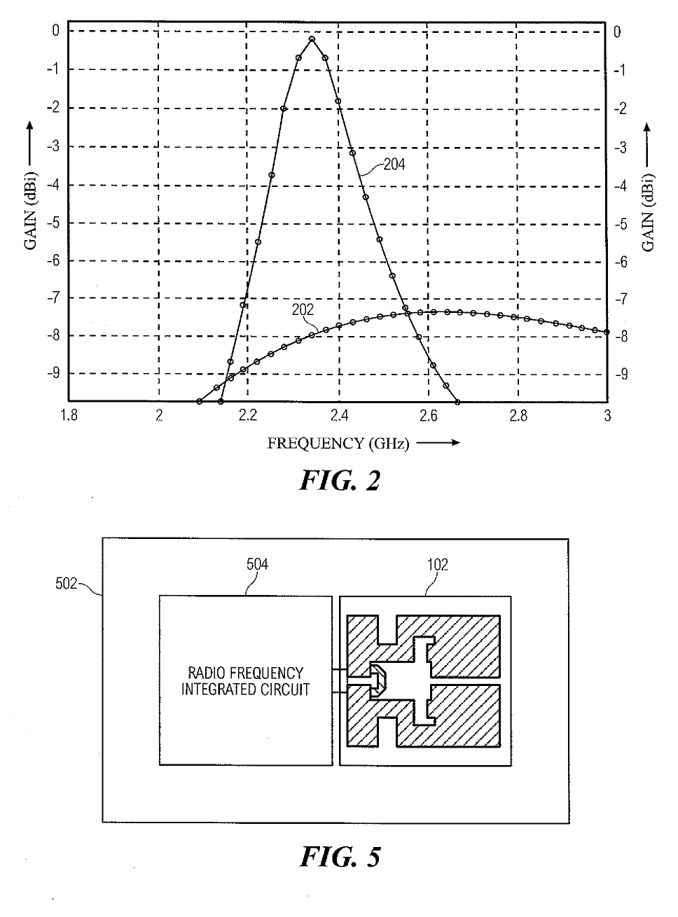

Referring now to FIG. 2, a graph illustrating a gain comparison between the folded dipole antenna 102 and a folded dipole antenna similar in design to the folded dipole antenna 102 but without the metallic radiating element 104 is shown. The X-axis represents the frequency of RF waves in giga-hertz (GHz). The Y-axis represents the gain in decibel units (dBi). The graph was obtained using an electromagnetic simulator. Curve 202 illustrates the gain of the folded dipole antenna similar in design to the folded dipole antenna 102 but without the metallic radiating element 104. Curve 204 illustrates the gain of the folded dipole antenna 102. Curve 202 shows that the folded dipole antenna similar in design to the folded dipole antenna 102, but without the metallic radiating element 104, attains a peak gain of about −7.5 dBi at a frequency of about 2.6 GHz. Whereas, curve 204 shows that the folded dipole antenna 102 attains a peak gain of about 0 dBi at a frequency of about 2.3 Hz. The folded dipole antenna 102 resonates at an operating frequency of about 2.3 GHz. The folded dipole antenna 102 exhibits better gain characteristics as compared to the folded dipole antenna similar in design to the folded dipole antenna 102 but without the metallic radiating element 104.

Referring now to FIG. 3, a radiation pattern illustrating the vertical and horizontal polarization of the folded dipole antenna 102, in vertical configuration, is shown, in accordance with an embodiment of the present invention. The radiation pattern was obtained using an electromagnetic simulator. Radiation pattern 302 illustrates vertical polarization of the folded dipole antenna 102 in vertical configuration, while radiation pattern 304 illustrates horizontal polarization of the folded dipole antenna 102 in vertical configuration. Both the radiation patterns, 302 and 304, were measured at a radiating frequency of 2.4 GHz. FIG. 3 illustrates that the folded dipole antenna 102, in vertical configuration, has a dominant propagation wave front in a direction along Z-axis.

Referring now to FIG. 4, a radiation pattern illustrating the vertical and horizontal polarization of the folded dipole antenna 102, in horizontal configuration, is shown. The radiation pattern was obtained using an electromagnetic simulator. Radiation pattern 402 illustrates the vertical polarization of the folded dipole antenna 102 in horizontal configuration and radiation pattern 404 illustrates the horizontal polarization of the folded dipole antenna 102 in horizontal configuration. Both the radiation patterns 402 and 404 were measured at a radiating frequency of 2.4 GHz. FIG. 4 illustrates that the folded dipole antenna 102, in horizontal configuration, has a dominant propagation wave front in a direction along its Z-axis.

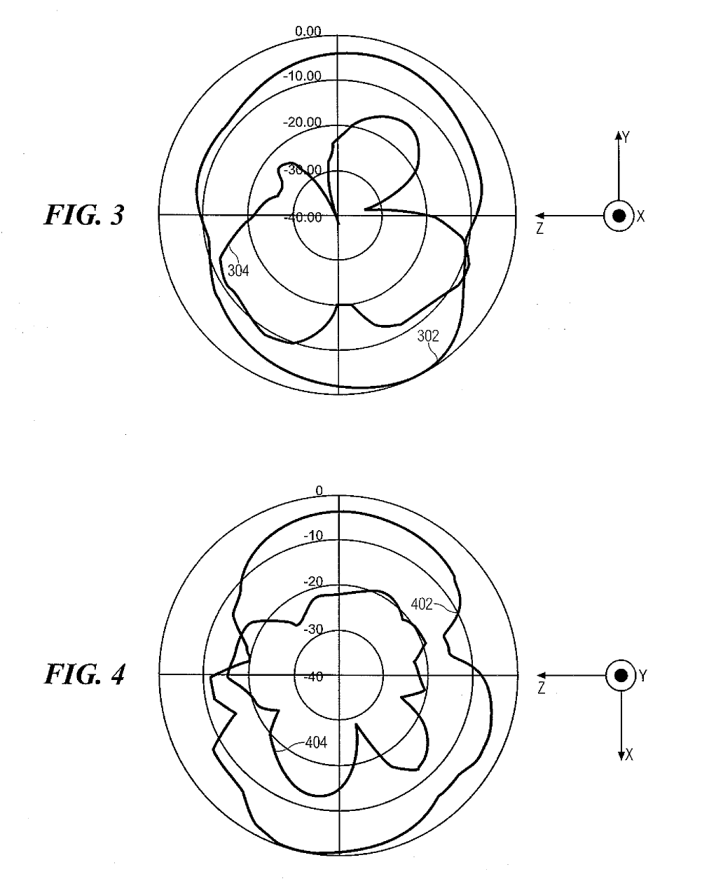

Referring now to FIG. 5, a block diagram of a wireless communication device 502 with the folded dipole antenna 102 is shown, in accordance with an embodiment of the present invention. The wireless communication device 502 includes a Radio Frequency Integrated Circuit (RFIC) 504. The RFIC 504 has a pair of differential ports that are connected to the two input ports 112 of the folded dipole antenna 102.

In various embodiments of the present invention, the wireless communication device 502 may include, but is not limited to, a cellular telephone, a laptop, a Personal Digital Assistant (PDA), a radio set, a wireless controller and a pager. The wireless communication device 502 may be compatible with various industrial specifications for wireless communication, e.g., Bluetooth, WLAN, Zigbee, and the like. In an embodiment of the present invention, the wireless communication device 502 may include a transmitting folded dipole antenna and a receiving folded dipole antenna, which are the same as the folded dipole antenna 102. The transmitting folded dipole antenna and the receiving folded dipole antenna may be fabricated in a stacked structure on the PCB. The transmitting folded dipole antenna receives RF signals from the RFIC 504 and radiates the RF signals over the air. The receiving folded dipole antenna detects RF waves and provides them to the RFIC 504 for further processing. In one example, the transmitting folded dipole antenna and the receiving folded dipole antenna may be planar inverted-F antennas (PIFA).

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A folded dipole antenna for at least one of transmitting and receiving radio frequency (RF) waves, the folded dipole antenna comprising:
a first radiating strip;
a second radiating strip, wherein the second radiating strip is separated from the first radiating strip by a predetermined distance, wherein the first radiating strip and the second radiating strip form a dipole; and
a metallic radiating element located between the first radiating strip and the second radiating strip.

2. The folded dipole antenna of claim 1, wherein the metallic radiating element is generally U-shaped.

3. The folded dipole antenna of claim 1, wherein a combined length of the first radiating strip and the second radiating strip is equal to about one-fourth of the wavelength of the RF waves.

4. The folded dipole antenna of claim 1, wherein the folded dipole antenna is a planar inverted-F antenna (PIFA).

5. The folded dipole antenna of claim 1, further comprising a ground plane connected to the first and second strips that is parallel to a plane of the first radiating strip, the second radiating strip and the metallic radiating element.

6. The folded dipole antenna of claim 1, wherein the first radiating strip, the second radiating strip, the metallic radiating element and the ground plane are formed on a printed circuit board.

7. The folded dipole antenna of claim 1, wherein the first and second radiating strips are mirror images of each other.

8. A wireless communication device, comprising:
a transmitting folded dipole antenna, the transmitting folded dipole antenna comprising:
a first radiating strip;
a second radiating strip that is separated from the first radiating strip by a predetermined distance, wherein the first radiating strip and the second radiating strip form a first dipole; and
a first metallic radiating element located between the first radiating strip and the second radiating strip;
a receiving folded dipole antenna, the receiving folded dipole antenna comprising:
a third radiating strip;
a fourth radiating strip separated from the third radiating strip by a predetermined distance, wherein the third radiating strip and the fourth radiating strip form a second dipole; and
a second metallic radiating element located between the third radiating strip and the fourth radiating strip; and
a radio frequency integrated circuit (RFIC) connected to the transmitting folded dipole antenna and the receiving folded dipole antenna.

9. The wireless communication device of claim 8, wherein the first and second metallic radiating elements are generally U-shaped.

10. The folded dipole antenna of claim 8, wherein the first and second radiating strips are mirror images of each other, and the third and fourth radiating strips are mirror images of each other.

11. The wireless communication device of claim 8, wherein the transmitting folded dipole antenna and the receiving folded dipole antenna are laid out in a stacked structure on a printed circuit board.

12. The wireless communication device of claim 8, wherein the transmitting folded dipole antenna is a planar inverted-F antenna (PIFA).

13. The wireless communication device of claim 8, wherein the receiving folded dipole antenna is a planar inverted-F antenna (PIFA).
